(19) United States
(12) Patent Application Publication
(10) Pub. No.: US 2025/0156248 A1
(43) Pub. Date: May 15, 2025

(54) API CALL METHOD, API CALL APPARATUS, ELECTRONIC DEVICE AND NON-TRANSITORY COMPUTER READABLE STORAGE MEDIUM

(71) Applicant: Samsung Electronics Co., Ltd., Suwon-si (KR)

(72) Inventors: Yanbo LIU, Suwon-si (KR); Hongze WU, Suwon-si (KR); Xiao KAN, Suwon-si (KR); Jingyan JIANG, Suwon-si (KR); Yinxiu GUO, Suwon-si (KR)

(73) Assignee: Samsung Electronics Co., Ltd., Suwon-si (KR)

(21) Appl. No.: 18/407,956

(22) Filed: Jan. 9, 2024

(30) Foreign Application Priority Data
Nov. 13, 2023 (CN) 202311508042.1

(51) Int. Cl. G06F 9/54

(52) U.S. Cl. CPC G06F 9/541

(57) ABSTRACT

Various example embodiments of the inventive concepts provide an Application Programming Interface (API) call method, an API call apparatus, an electronic device, and/or a non-transitory computer readable storage medium. The API call method includes determining, using processing circuitry of an electronic device, one or more rules corresponding to an API from a rule set in response to an API call request from an operating system (OS) of the electronic device associated with the API, the API including an Input/Output Control (ioctl) interface, determining, using the processing circuitry, whether to allow the API call request based on the one or more rules, and executing, using the processing circuitry, a call of the API corresponding to the API call request based on results of the determining.

This U.S. non-provisional application claims the benefit of priority under 35 U.S.C. § 119 to Chinese Patent Application No. 202311508042.1 filed on Nov. 13, 2023. The entire disclosure of the above-referenced application is hereby incorporated by reference.

### BACKGROUND

Various example embodiments of the inventive concepts relate to a field of computer technology, and in more particular, to an API call method, an API call apparatus, an electronic device, and/or a non-transitory computer readable storage medium for decreasing and/or preventing a device driver from being abused by an Application Programming Interface (API) call which attempts to trigger a security vulnerability.

With the development of computer technology, an API, which serves as a bridge for information interaction between computer components, is widely used. However, due to flexibility and openness of API calls, there may be certain security issues associated with the use of the API, such as API abuse, abnormal API access, and/or security attacks against the API. These security issues can lead to anomalies and/or vulnerabilities in devices.

The above information is presented as background technical information only to aid in understanding the example embodiments of the inventive concepts. No admission has been made as to whether any of the foregoing is applicable as prior art with respect to the example embodiments of the inventive concepts.

### SUMMARY

In order to address at least the above problems and/or disadvantages, various example embodiments of the inventive concepts provide an API call method, an API call apparatus, an electronic device, and/or a non-transitory computer readable storage medium.

According to at least one example embodiment of the inventive concepts, an Application Programming Interface (API) call method is provided, which includes: determining, using processing circuitry of an electronic device, one or more rules corresponding to an API from a rule set in response to an API call request from an operating system (OS) of the electronic device associated with the API, the API including an Input/Output Control (ioctl) interface; determining, using the processing circuitry, whether to allow the API call request based on the one or more rules; and executing, using the processing circuitry, a call of the API corresponding to the API call request based on results of the determining.

According to at least one example embodiment, the determining the one or more rules corresponding to the API from the rule set comprises: determining the one or more rules corresponding to the API from the rule set based on a command number of the API.

According to at least one example embodiment, the rule set is included in a hash table, the hash table includes a key corresponding to the command number of the API, and one or more values corresponding to the key represent the one or more rules corresponding to the API, and the determining the one or more rules corresponding to the API from the rule set based on the command number of the API comprises, traversing a linked list included in the hash table corresponding to the command number of the API based on the key to determine the one or more rules corresponding to the API, the one or more rules included in one or more nodes of the linked list.

According to at least one example embodiment, the determining whether to allow the API call based on the one or more rules further comprises: determining whether the API is being abused by comparing a status bitmap corresponding to the API with the one or more rules.

According to at least one example embodiment, the determining whether to allow the API call includes: comparing values included in the status bitmap corresponding to the API with call sequence values included in each of the one or more rules, allowing the API call in response to the one or more rules including call sequence values which are the same as the values of the status bitmap corresponding to the API, and prohibiting the API call in response to none of the one or more rules including call sequence values which are the same as the values of the status bitmap corresponding to the API.

According to at least one example embodiment, the API call method further includes: determining, using the processing circuitry, the rule set corresponding to a target device from a plurality of preset rule sets in response to an open function of the API being executed to turn on the target device.

According to at least one example embodiment, the API call method further includes: creating, using the processing circuitry, a status bitmap corresponding to the API in response to an open function of the API being executed to turn on a target device, the status bitmap including API call records and API call results corresponding to the API; and updating, using the processing circuitry, the status bitmap corresponding to the API in response to executing calls of the API.

According to at least one example embodiment, the updating the status bitmap comprises, in response to a second position in the status bitmap corresponding to the API being 0, the second position being used to record the API call results corresponding to the API: updating a first position in the status bitmap corresponding to the API to 1 in response to a successful calling of the API, the first position being used to record the API call record associated with the API; and updating a second position to 1 in the status bitmap corresponding to the API and updating the first position to 0 in response to a failed calling of the API.

According to at least one example embodiment of the inventive concepts, an Application Programming Interface (API) call apparatus is provided, which includes: processing circuitry configured to, determine one or more rules corresponding to an API from a rule set in response to an API call request from an operation system of the apparatus for the API, the API comprises an Input/Output Control (ioctl) interface, determine whether to allow the API call request based on the one or more rules, and execute a call of the API corresponding to the API call request based on results of the determining.

According to at least one example embodiment, the processing circuitry is further configured to determine the one or more rules corresponding to the API by: determining the one or more rules corresponding to the API from the rule set based on a command number of the API.

According to at least one example embodiment, the rule set is included in a hash table, the hash table includes a key corresponding to the command number of the API, and one or more values corresponding to the key represents the one or more rules corresponding to the API, and the processing circuitry is further configured to determine the one or more rules corresponding to the API by: traversing a linked list included in the hash table corresponding to the command number of the API based on the key to determine the one or more rules corresponding to the API, the one or more rules included in one or more nodes of the linked list.

According to at least one example embodiment, the processing circuitry is further configured to determine whether to allow the API call based on the one or more rules by: determining whether the API is being abused by comparing a status bitmap corresponding to the API with the one or more rules.

According to at least one example embodiment, the processing circuitry is further configured to determine whether to allow the API call by: comparing values included in the status bitmap corresponding to the API with call sequence values included in each of the one or more rules, allowing the API call in response to the one or more rules including call sequence values which are the same as the values of the status bitmap corresponding to the API, and prohibiting the API call in response to none of the one or more rules including call sequence values which are the same as the values of the status bitmap corresponding to the API.

According to at least one example embodiment, the processing circuitry is further configured to determine the rule set corresponding to a target device from a plurality of preset rule sets in response to an open function of the API being executed to turn on the target device.

According to at least one example embodiment, the processing circuitry is further configured to: create a status bitmap corresponding to the API in response to an open function of the API being executed to turn on a target device, the status bitmap including API call records and API call results corresponding to the API; and update the status bitmap corresponding to the API in response to executing calls of the API.

According to at least one example embodiment, the processing circuitry is further configured to update the status bitmap corresponding to the API by: updating a first position in the status bitmap corresponding to the API to 1 in response to a successful calling of the API, the first position being used to record the API call record associated with the API; and updating a second position in the status bitmap corresponding to the API to 1 and updating the first position to 0 in response to a failed calling of the API.

According to at least one example embodiment of the inventive concepts, an electronic device is provided, which includes at least one memory storing computer executable instructions and processing circuitry configured to execute the computer executable instructions to perform an API call method.

According to at least one example embodiment of the inventive concepts, a non-transitory computer-readable storage medium is provided. Instructions in the non-transitory computer-readable storage medium, when being executed by processing circuitry, cause the processing circuitry to determine one or more rules corresponding to an API from a rule set in response to an API call request from an operation system of the apparatus for the API, the API comprises an Input/Output Control (ioctl) interface, determine whether to allow the API call request based on the one or more rules, and execute a call of the API corresponding to the API call request based on results of the determining.

The API call method, the API call apparatus, the electronic device, and the non-transitory computer readable storage medium according to some example embodiments of the inventive concepts, on the one hand, ensure that an application calls an interface in a normal manner, by adding a new rule mechanism to control an API call using simple rules, thereby decreasing and/or preventing API abuse from triggering an exception or security vulnerability (e.g., a 0 day security vulnerability), and on the other hand, by making a limit on security vulnerability triggering through updating the rules, protect a device driver from an attack before a developer completely fix the security vulnerability, and quickly respond to an exception or a security vulnerability (for example, the 0 day security vulnerability).

Benefits and/or advantages obtainable from one or more example embodiments of the inventive concepts may not be limited by the above benefits and/or advantages, and other benefits and/or advantages not mentioned may be clearly understood by one of ordinary skill in the art to which the example embodiments of the inventive concepts belong from the following description.

### BRIEF DESCRIPTION OF THE DRAWINGS

The foregoing and other aspects, features and advantages of one or more example embodiments of the inventive concepts will become more apparent by the following description in conjunction with the accompanying drawings, wherein:

FIG. 1 is a flowchart illustrating an API call method according to at least one example embodiment of the inventive concepts;

FIG. 2 is a diagram illustrating an example of a data structure for a rule according to at least one example embodiment of the inventive concepts;

FIG. 3 is a diagram illustrating an example of a data structure for a rule set according to at least one example embodiment of the inventive concepts;

FIG. 4 is a diagram illustrating an example of an API status bitmap according to at least one example embodiment of the inventive concepts;

FIG. 5 is a diagram illustrating an application of an API call method according to at least one example embodiment of the inventive concepts;

FIG. 6 is a block diagram illustrating an API call apparatus according to at least one example embodiment of the inventive concepts; and

FIG. 7 is a block diagram illustrating an electronic device according to at least one example embodiment of the inventive concepts.

### DETAILED DESCRIPTION

Various example embodiments of the inventive concepts will be described clearly and completely in combination with the accompanying drawings.

The terms “include/including” or “comprise/comprising” used in this specification, indicate the presence of stated features, integers, steps, operations, elements, components, and/or combinations thereof, but do not preclude the presence or addition of one or more other features, integers, steps, operations, elements, components, and/or combinations thereof. It should be understood that, although the terms “first”, “second”, “third”, etc. are used to describe various types of information, the information should not be limited by these terms. These terms are only used to distinguish one type of information from another type of information. For example, without departing from the scope of the example embodiments of the inventive concepts, first information may be referred to as second information; and similarly, second information may be referred to as first information. As used herein, the term “if” may be understood to mean “when”, “while”, or “in response to” depending on the context.

In addition, “at least one of several items” appearing in one or more example embodiments of the inventive concepts all means that there are three kinds of juxtaposition situations: “any one of these items”, “a combination of any number of these items”, and “all of these items”. For example, “including at least one of A and B” includes the following three juxtaposition situations: (1) including A; (2) including B; (3) including A and B. As another example, “performing at least one of operations 1 and 2”, that is, means the following three juxtaposition situations: (1) performing operation 1; (2) performing operation 2; (3) performing operations 1 and 2.

In the related technology, it is common to call a plurality of APIs based on a call sequence of the APIs, but such manner may lead to API abuse triggering a security vulnerability. A case of the API abuse triggering the security vulnerability, caused by the call sequence problem, usually includes: (1) a “B” API interface (e.g., B interface) must be called before an “A” API interface (e.g., A interface) is called (e.g., the B interface has a dependency on the A interface, etc.), but if the A interface is called directly without calling the B interface, the security vulnerability will be triggered when calling the A interface; and/or (2) the B interface must be called successfully before the A interface is called, and even though in a case that the A interface is called after the B interface is called by multiple times, if the last call of the B interface fails, the security vulnerability will be triggered when the A interface is called.

In this regard, the related technology usually protects a device driver by monitoring API calls and/or limiting the calling of APIs. For example, a manner of monitoring the API call includes: monitoring a file path of the API call during a load function by using a hook function, and rejecting a load request if the device driver corresponding to the file path belongs to a device driver in a preset driver feature library, and/or, monitoring the call of the API by using the hook function, and analyzing parameters of the call to determine whether the parameters have malicious and/or potentially malicious features. However, the manner of monitoring the call has a defect wherein only a device driver that is configured to be secure may be loaded (e.g., only allowing device drivers on a whitelist or approved list of device drivers to be loaded, etc.), and/or only being capable of analyzing the parameters of a single API and/or limited set of preset APIs (e.g., being unable to analyze the parameters of newer and/or APIs that are not on the preset list of APIs, etc.). For example, a manner of limiting the API call (e.g., call, etc.) includes: controlling a call frequency of the API within a time unit (e.g., preset and/or configured time interval) using a queue assigned to each API, and/or, establishing a state machine for all messages transmitted between communication protocols and identifying an API call of a message outside of the state machine as an abused API call and/or potentially abusive API call, etc. This manner of limiting calls has a defect in that only the call frequency of the API is considered without defending against potential abuse caused by a random (and/or pseudo-random) sequence of calls of a plurality of APIs, and it is technically difficult to establish a perfect and/or satisfactory state machine for all interfaces (e.g., APIs).

In summary, the related technology cannot and/or do not fundamentally solve the problems of API abuse due to the association of the plurality of APIs, and there are many defects, such as, the manner of protecting the driver only by limiting access control permissions of APIs cannot decrease and/or prevent a user having security permissions from being victim to and/or exploiting a security vulnerability in the device driver; the parameter checking and the call frequency checking can only defend against the abuse of a single API, and cannot defend against the abuse caused by random API calls associated with a plurality of APIs; that establishing a sequence of which applications call APIs normally using a state machine is difficult to establish a limited and perfect state machine for the driver, and so on.

Various example embodiments of the inventive concepts provide an API call method, an API call apparatus, an electronic device, and/or a non-transitory computer readable storage medium that decreases and/or prevents API abuse by utilizing fewer resources without limiting and/or reducing the limitations on the use of a device driver, by taking into account the above problems of the related technology. The API call method, the API call apparatus, the electronic device, and the non-transitory computer readable storage medium according to some example embodiments of the inventive concepts, on one hand, may use simple rules to control an API call by adding a new rule mechanism, and on the other hand, may also protect the devices from an attack before a developer completely fixes the security vulnerability, by making a limit on security vulnerability triggering by updating the rules.

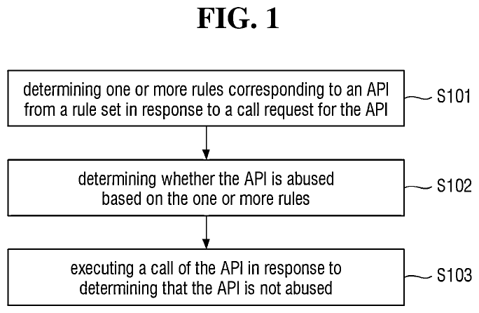

An API call method, an API call apparatus, an electronic device, and/or a non-transitory computer readable storage medium according to one or more example embodiments of the inventive concepts will be described below with reference to FIGS. 1 to 7.

According to at least one example embodiment of the inventive concepts, the API may include an input/output (I/O) control (ioctl) interface for managing an I/O channel. It is noted that, although only the ioctl interface is shown as an API in the example embodiments of the inventive concepts, is the example embodiments are not limited thereto, and the API may also include other interfaces with similar functionality and/or structure as will be appreciated by those of ordinary skill in the art.

FIG. 1 is a flowchart illustrating an API call method of at least one example embodiment of the inventive concepts.

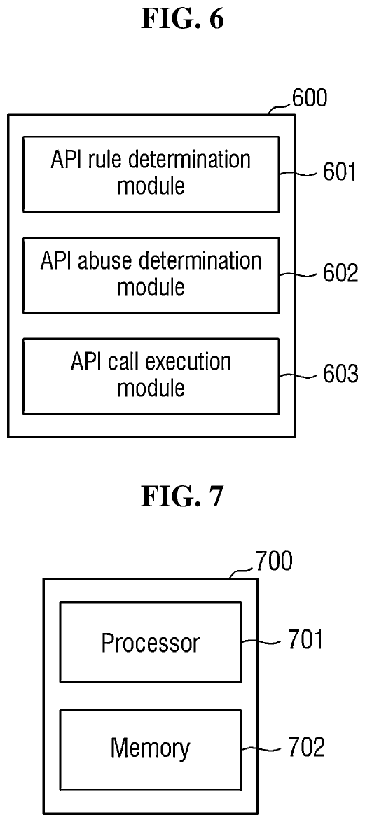

Referring to FIG. 1, at operation S101, one or more API access rules (e.g., rules and/or access rules, etc.) corresponding to an API is determined by an API call apparatus (see FIG. 6, etc.), such as a computing device, etc., from a rule set in response to a call request for the API. For example, according to at least one example embodiment of the inventive concepts, an access to a related interface is limited by adding rules related to API access in, for example, an operating system, and if the API call (e.g., API access) satisfies the rules, the API call is allowed, wherein the rules used for limitations are determined from the rule set corresponding to this API.

Configurations of the API, the rule, and the rule set are described in detail according to various example embodiments of the inventive concepts below.

According to at least one example embodiment of the inventive concepts, a data structure of the API (and/or a API function) (e.g., including, but not limited to, an ioctl command and/or ioctl function, etc.) may be a 32-bit integer, and for example, may include the following parameters: an 8-bit Magic Number, a 9-bit Command Number, a 2-bit Direction, and/or a 13-bit or 14-bit data type, but the example embodiments are not limited thereto.

According to at least one example embodiment of the inventive concepts, a magic number may be a unique number and/or character that is used to distinguish one set of API calls (for example, but not limited to, the ioctl interface) from other API calls (for example, but not limited to, the ioctl interface). For example, a device number corresponding to a device (e.g., hardware device, etc.) may be used as the magic number, e.g., in this case, one rule set may correspond to one magic number and API commands for the API corresponding to the target device all have the same magic number, etc.

According to at least one example embodiment of the inventive concepts, the command number may be a numerical number assigned to each API (for example, but not limited to, the ioctl interface) that is used to distinguish APIs within the same set of APIs. That is, the command number according to at least one example embodiment of the inventive concepts may be used as an identifier of the API to further identify the rules corresponding to this API. Thus, according to at least one example embodiment of the inventive concepts, the identifying one or more rules corresponding to the API from the rule set includes: determining the one or more rules corresponding to the API from the rule set based on a command number of the API.

For example, the rule may be defined that, for example, there must be a specific API command (e.g., preceding API command) that has been called normally before the corresponding API (e.g., subsequent API command, dependent API command, etc.) is called. For example, in the case where the API command is the ioctl command (or the API is the ioctl interface), the rule may be defined as follows:
ioctl⁰: ioctl¹ & ioctl² & ioctl³ & . . . ioctlⁿ

This definition may indicate that, ioctl⁽¹⁻ⁿ⁾ must be successfully executed before the ioctl⁰ is executed, otherwise a device driver code corresponding to the ioctl⁰ will not be executed and a return operation will be performed and/or directly performed, etc. Although the API command is illustrated as the ioctl command, the example embodiments of the inventive concepts are not limited thereto.

As an example, assuming that a device has three ioctl interfaces denoted as A interface, B interface, and C interface, and the C interface is the protected interface, the following two rules may be defined for interface C, but the example embodiments are not limited thereto:
(1) an “AND” rule: all other interfaces in the rule (e.g., the A interface and the B interface, etc.) must be successfully executed before the C interface may be executed. In this case, the rule may be defined as C: A & B.
(2) an “OR” rules: only one of the other interfaces in the rule (e.g., the A interface or the B interface, etc.) needs to be successfully executed before the C interface is executed. In this case, the rule may be defined as C: A, C: B.

For example, when direct execution of an VIDIOC_REQBUFS interface may trigger a security vulnerability, and when execution of the VIDIOC_REQBUFS interface, in a case of an VIDIOC_S_FMT interface being firstly successfully executed, does not trigger a security vulnerability, the rule for the protected VIDIOC_REQBUFS interface may be defined, for example, as VIDIOC_REQBUFS: VIDIOC_S_FMT.

Although the example embodiments of the inventive concepts only indicates that the definition of rules includes “AND” rules and “OR” rules, the rules according to the example embodiments of the inventive concepts may also include any other applicable rules.

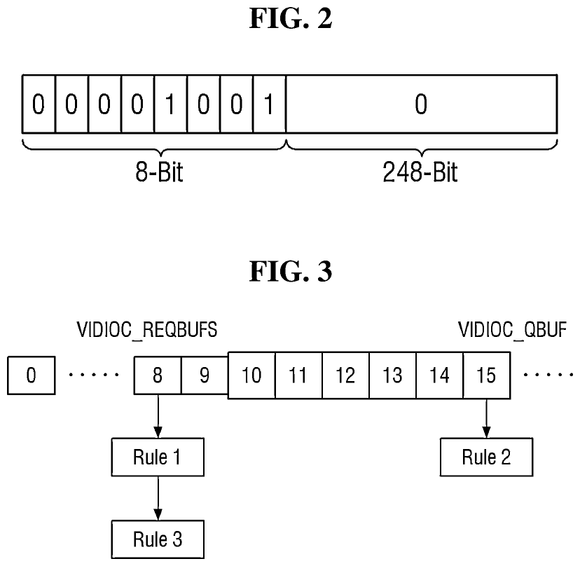

According to at least one example embodiment of the inventive concepts, the rule(s) may be configured and/or preconfigured with a set of call sequence values and may be configured and/or preconfigured in the rule set. One rule according to at least one example embodiment of the inventive concepts may be represented by four unsigned long integers, e.g., the rule for the VIDIOC_QBUF interface may be represented as a data structure in FIG. 2, and the call sequence values for the VIDIOC_QBUF interface may correspond to the values in FIG. 2, but the example embodiments are not limited thereto.

According to at least one example embodiment of the inventive concepts, for example, but without limitation, the rule may be determined and/or predetermined based on a Proof of Concept (PoC) of security vulnerabilities and/or an interface usage specification, etc. For example, the rules may be determined and/or predetermined by analyzing the POC of the security vulnerabilities, etc.

According to at least one example embodiment of the inventive concepts, the rules for different APIs of the same device may belong to one rule set, and when the rule set is determined, the one or more rules for controlling a call of a specific API may be determined from a set of rules indicated by the rule set. For example, according to at least one example embodiment of the inventive concepts, the rule set is represented by a hash table, wherein a Key of the hash table represents the command number of the API and a Value of the hash table represents the rule, but is not limited thereto.

As another example, the determining of the one or more rules corresponding to the API from the rule set based on the command number of the API includes: determining a node in the hash table corresponding to the command number as a head node of a linked list corresponding to the node, by indexing by the command number of the API; and traversing the linked list starting from the head node to determine the one or more rules corresponding to one or more nodes of the linked list, but is not limited thereto.

Various examples of this will be described below in conjunction with FIG. 3. FIG. 3 is a diagram illustrating a data structure of a rule set according to at least one example embodiment of the inventive concepts. In FIG. 3, it is assumed that a command number for the VIDIOC_REQBUFS interface is 8 and a command number for the VIDIOC_QBUF interface is 15, but the example embodiments are not limited thereto. Referring to FIG. 3, based on the command number of 8 for the VIDIOC_REQBUFS interface, a node corresponding to 8 is determined as a head node of a linked list, and two linked list nodes are determined by traversing this linked list, the two linked list nodes representing Rule 1 and Rule 3, respectively, but the example embodiments are not limited thereto. Referring to FIG. 3, based on the command number of 15 for the VIDIOC_QBUF interface, a node corresponding to 15 is determined as a head node of one linked list, and a linked list node corresponding to Rule 2 may be determined by traversing this linked list, but is not limited thereto.

That is, one head node may be determined based on the key associated with an API, the key being determined based on the command number of the API, and the one or more rules may be one or more nodes in a bi-directional cyclic linked list hanging behind this head node, but the example embodiments are not limited thereto. Since the number or other details of the rules are unknown at this point, this linked list is traversed to determine and/or ultimately determine the one or more rules corresponding to this head node and the API associated with the head node.

In addition, during a process of traversing the linked list, there may be a case where there is no subsequent node after the head node. In this case, no rules are configured for the current API, therefore, there is no need to perform the detection of whether the API call is abused or not, and the other subsequent processes may be skipped and the call of the API may be executed directly (e.g., without further rule processing, etc.). For example, referring to FIG. 3, when the command number of a specific API is 9, since there is no linked list under this node, it may be assumed that there is no rule limitation for this specific API, and the call of the specific API may be directly executed.

Returning to FIG. 1, according to at least one example embodiment of the inventive concepts, the rule set corresponding to a target device is determined from a plurality of preset rule sets when an open function is executed to turn on the target device to be driven by the API, but is not limited thereto. According to at least one example embodiment of the inventive concepts, for example, but not limited to, the plurality of rule sets may be preset and/or configured based on the PoC of the security vulnerabilities and/or the interface usage specification. For example, the rule sets may be determined and/or predetermined by analyzing the PoC of the security vulnerabilities, etc.

Specifically, when an application turns on the target device, it executes the open API function, determines the rule set corresponding to the target device from the plurality of predefined and/or preset rule sets, and saves the determined rule set in a File structure created for the target device, etc. Here, the plurality of preset rule sets may be predetermined or preconfigured, but it is not limited thereto. For example, the plurality of preset rule sets may be dynamically updated (e.g., updated during run-time, etc.), and the updated plurality of preset rule sets may be used to determine the rule set corresponding to the target device.

According to at least one example embodiment of the inventive concepts, for example, but not limited to, the determination of the rule set may be implemented, by modifying a do_sys_open function to add an interface Init for performing an initialization processing, wherein the interface Init may configure one rule set for each device and may be used to find the rule set, but is not limited thereto. When the open function is executed, the rule set corresponding to the target device may be determined from the plurality of configured and/or pre-configured rule sets for different devices.

In addition, according to at least one example embodiment of the inventive concepts, the determination of a set of rules included in the rule set may be implemented through the use of a Rule Set Pointer (RSP), for example, but is not limited thereto, and the saving and/or storing of the rule set may be implemented by modifying the File structure. For example, when the open function is executed, the RSP corresponding to the determined rule set is added into the File structure for subsequent use, wherein the Rules Set Pointer may be used to point to the rule set, etc.

The API call method according to at least one example embodiment of the inventive concepts further includes searching for the rule set based on a string path of a node of the device when the open function is executed. Specifically, a dictionary tree may be built for the string paths of the nodes of different devices, and a leaf node of the dictionary tree is the RSP corresponding to the device, but the example embodiments are not limited thereto. The efficiency of loading the rule set may be improved in this manner.

The API call method according to at least one example embodiment of the inventive concepts does not overly restrict a user from programming with the interface and provides significant security benefits in a case that the overhead introduced may be controlled within an acceptable and/or improved level.

In addition, since the API call method according to at least one example embodiment of the inventive concepts does not directly restrict the interface but only restricts the call of the interface, the device driver may be used in a safe manner.

Furthermore, since the API call method according to at least one example embodiment of the inventive concepts uses the rule set to determine the rules for limiting API abuse, limitations may be performed for calls that are interdependent between plurality of APIs, rather than just for a single API, etc.

When the one or more rules are determined, the determination operation of API abuse may be performed.

At operation S102, determination of whether the API is abused is based on the one or more rules. Specifically, determining whether the API is abused is based on the rule(s) determined at operation S102, and a determination of whether to allow execution of the API is based on the results of the determination of whether the API is abused.

According to at least one example embodiment of the inventive concepts, the determining whether the API is abused based on the one or more rules includes: determining whether the API is abused based on a result of comparing an API Status Bitmap (ASB) with the one or more rules.

The API status bitmap according to at least one example embodiment of the inventive concepts will be specifically described below.

The API call method according to at least one example embodiment of the inventive concepts further includes: creating the API status bitmap for recording an API call record and an API call result, when the open function is executed to turn on the target device to be driven by the API; and updating the API status bitmap in response to executing the call of the API, etc.

For example, a data structure of the API status bitmap according to at least one example embodiment of the inventive concepts may be similar to the data structure of the rule, and may be used to record which API(s) (e.g., the ioctl interface, etc.) are called by the software application (e.g., device driver, operating system, computer program, app, etc.) when the application performs a driving operation on a device, and the results of the API calls, but is not limited thereto. Here, the API call result may include a successful call and a failed call (e.g., unsuccessful call, etc.), wherein, when the API call is successfully executed, the API call result is successful, and when the API call is executed but fails due to some other reasons (that is, the reasons other than a reason limited by the rule according to at least one example embodiment of the inventive concepts, for example, a format is not supported), the API call result is failed, etc.

Specifically, according to at least one example embodiment of the inventive concepts, when the open function is executed to turn on the target device to be driven by the API, an initial API status bitmap may be created and/or generated, and the created and/or generated initial API status bitmap may be saved to the File structure (e.g., by adding an API status bitmap pointer into the File structure), and in a subsequent process of API call, the API status bitmap is updated and/or continuously updated. Thus, the API status bitmap may be used to record all API call processes from the time that the application turns on the device to the time that it turns off the device.

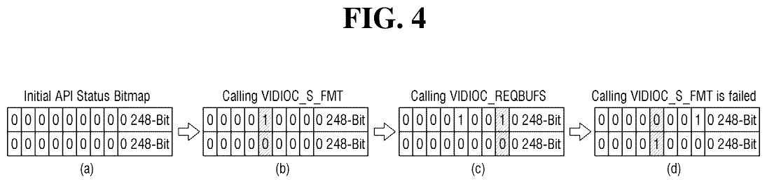

According to at least one example embodiment of the inventive concepts, the API status bit map may be similar to the data structure of the rule having 256 bits, and may, for example, include 2 unsigned long integer arrays of length 4, wherein one array is used to record a call record of the API, and the other array is used to record a call result of the API, but is not limited thereto. Herein, the number of bits of the API status bitmap is used only as an example, and the example embodiments of the inventive concepts are not limited thereto. FIG. 4 is a diagram illustrating an example of an API status bit map according to at least one example embodiment of the inventive concepts. In FIG. 4, the VIDIOC_S_FMT interface and the VIDIOC_REQBUFS interface are used as examples.

According to at least one example embodiment of the inventive concepts, the initial API status bitmap may have values all of 0, but is not limited thereto. Referring to FIG. 4, the API status bitmap in (a) of FIG. 4 is all 0.

According to at least one example embodiment of the inventive concepts, one or more positions for recording API call records may be referred to as a first position(s), wherein one first position corresponds to one API, but the example embodiments are not limited thereto. As an example, when the first position is 0, it may indicate that the API corresponding to this first position is not called, and in contrast, when the first position is 1, it may indicate that the API corresponding to this first position is called, etc.

Referring to FIG. 4, a first row of each API status bitmap may indicate the first positions, but is not limited thereto. Referring to (b) in FIG. 4, when a VIDIOC_S_FMT interface is called, the first position corresponding to the VIDIOC_S_FMT interface is 1, etc. Referring to (c) in FIG. 4, when the VIDIOC_REQBUFS interface is called, the first position corresponding to the VIDIOC_REQBUFS interface is 1, etc.

Similarly, according to at least one example embodiment of the inventive concepts, one or more positions for recording API call results may be referred to as a second position(s), wherein one second position corresponds to one API, but the example embodiments are not limited thereto. As an example, when the second position is 0, it may indicate that, the call result of the API corresponding to this second position is successful in a case where this API is called and/or the API corresponding to this second position has not yet been called, and when the second position is 1, it may indicate that the call result of the API corresponding to this second position is failed, but the example embodiments are not limited thereto.

Referring to FIG. 4, a second row of each API status bitmap may indicate second positions, but is not limited thereto. For example, referring to (d) in FIG. 4, when a call of the VIDIOC_S_FMT interface fails due to the introduction of an unsupported format when the VIDIOC_S_FMT interface is called again, the second position corresponding to the VIDIOC_S_FMT interface is a 1. At this point, due to the failure of the call of the VIDIOC_S_FMT interface, the corresponding first position is changed to 0.

According to the above processes, the API status bitmap may be updated when the execution of the call of the API is completed. According to at least one example embodiment of the inventive concepts, the updating operation is performed when the second position corresponding to the API in the API status bit map is 0. That is, the updating of the API status bitmap may be performed when the position corresponding to the API indicates that the API has been successfully called or has not been called.

According to at least one example embodiment of the inventive concepts, the first position corresponding to the API in the API status bitmap is updated to 1 in response to a successful calling of the API. In the case of the successful call of the API, there is no need to make a change to the second position since the corresponding second position has previously been determined to be 0.

According to at least one example embodiment of the inventive concepts, the second position is updated to 1 and the first position is updated to 0 in response to a failed calling of the API. In the case of the failed call of the API, a change in the second position is required, and the subsequent process may determine that there has been a failed call of the API based on the second position.

According to at least one example embodiment of the inventive concepts, the above determination of abuse may be implemented, for example, by adding an interface update to a vfs_ioctl command to collect call status, but is not limited thereto.

The API call method according to at least one example embodiment of the inventive concepts may be used in practice to generate descriptor fd locks for each open function and is sufficiently computationally small for API status bitmap updating and abuse detection, and thus may avoid performance problems caused by mutual exclusion in concurrent scenarios.

According to at least one example embodiment of the inventive concepts, when determining whether the API is abused, the determination may be performed by using the saved API status bitmap and the aforementioned calling sequence values in the corresponding rule.

Since the API status bitmap records the status of previous API calls (e.g., which APIs have been called and the results of the API calls), whether the API is abused may be determined by comparing the recorded values of the API status bitmap with preset values. According to at least one example embodiment of the inventive concepts, the determining whether the API is abused based on the result of comparing the API status bitmap with the one or more rules includes: comparing values of the API status bitmap with configured and/or preconfigured call sequence values in each of the one or more rules; determining that the API is not abused, when there is a rule preconfigured with call sequence values which are the same as the values of the API status bitmap among the one or more rules; and determining that the API is abused, when there is no rule configured and/or preconfigured with call sequence values which are the same as the values of the API status bitmap among the one or more rules. In other words, it is determined that the API is abused when all rules corresponding to the API do not correspond to the API status bitmap, etc.

Specifically, whether the rule is consistent with the API status bitmap may be determined by comparing the values in the API status bitmap that represents API call records with calling sequence values of the rule, for example, by performing an AND operation between values in the first row of the API status bitmap illustrated in FIG. 4 and the call sequence values of the rule, etc.

According to at least one example embodiment of the inventive concepts, the above determination of abuse may be implemented, for example, by adding an interface check into a vfs_ioctl command, but is not limited thereto.

As such, the device is protected by making only minor modifications to the Virtual File System (VFS) without any changes to device driver source codes, and API abuse of, for example, a Linux, etc., device driver is defended against without affecting functionalities of the original device, but the example embodiments are not limited thereto.

In response to determining that the API is abused, the call of the API may be directly stopped and/or the call of the corresponding API is withdrawn (e.g., when the API is the vfs_ioctl interface, the vfs_ioctl interface is returned directly).

Returning to FIG. 1, at operation S103, a call of the API is executed in response to determining that the API is not abused. Specifically, for example, when the API is the vfs_ioctl interface, in response to determining that the vfs_ioctl interface is not abused, an ioctl code of the driver is executed normally by the electronic device, etc.

Upon completion of all API call operations, the device may be turned off by executing a close function. For example, but not limited to, the device may be turned off by executing the close function, at this point, the File structure created during the execution of the open function, as described above, is deleted, and accordingly, the rule set and API status bitmap stored in this File structure are destroyed, etc.

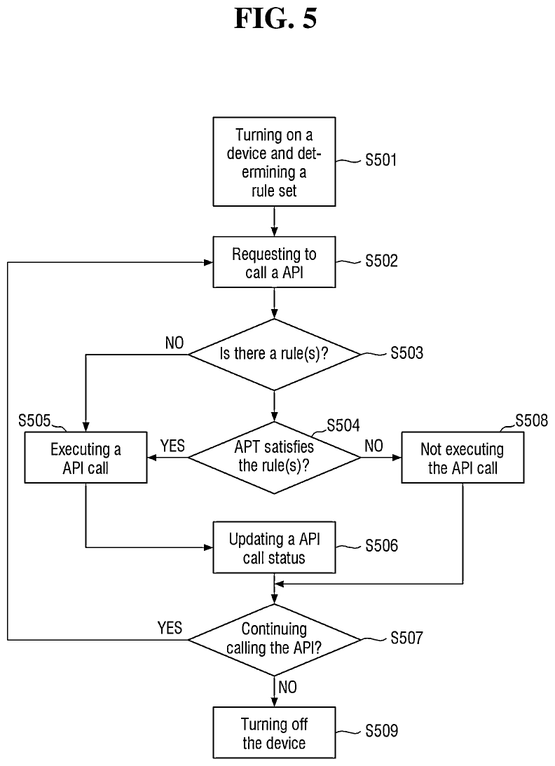

An example of an application of the API call method according to at least one example embodiment of the inventive concepts is described in detail below with reference to FIG. 5, but the example embodiments are not limited thereto. FIG. 5 is a diagram illustrating an application of an API call method according to at least one example embodiment of the inventive concepts. The details described above with reference to FIGS. 1 to 4 are all applicable to at least one example embodiment of FIG. 5 and will not be repeated herein to avoid repetition, but the example embodiments are not limited thereto.

Referring to FIG. 5, at operation S501, an open function is executed to turn on a device and identify and/or determine a rule set corresponding to the device, but is not limited thereto.

At operation S502, a call of an API is requested by an electronic device (and/or computing device, API calling apparatus, etc.), and at operation S503, is the electronic device determines whether there are one or more rules corresponding to the API.

Based on the determination that there is no one or more corresponding rules at operation S503, that is, there is no limitation on the call of this API, the electronic device proceeds to operation S505 to execute and/or directly execute the call of the API.

Based on the determination that there are one or more corresponding rules at operation S503, the electronic device determines whether the API satisfies one or more rules corresponding to the API at operation S504, that is, whether the API is abused based on the rules as described above.

Based on the determination that the API satisfies the one or more rules at operation S504, that is, that the determined and/or predetermined rules allow for the execution of the call of the API, the electronic device executes the call of the API at operation S505.

When the call of the API is executed by the electronic device, at operation S506, the electronic device updates the API call status, that is, the API status bitmap is updated based on the call of the API, as described above.

When the API call status is updated, at operation S507, the electronic device determines whether to continue calling this API and/or calling other APIs, etc.

In addition, based on the determination that the API does not satisfy the one or more rules at operation S504, that is, the determined and/or predetermined rules do not allow for (and/or prohibit) the execution of the call of the API, the call of the API is not executed by the electronic device at operation S508. In this case, the application returns directly and proceeds to a subsequent operation S507 to determine whether to proceed with the next API call, etc.

Based on the determination that calling the API is continued at operation S507, the electronic device returns to operation S502 and the API call request is re-initiated.

Based on the results of the determination, the calling of the API is continued at operation S508, and the device may be turned off at operation S509, etc.

Since the details of the operations of FIG. 5 are specifically described above with reference to various example embodiments, they will not be repeated here.

In addition, the API call method according to at least one example embodiment of the inventive concepts are tested on an example project, and the test result shows that the API call method according to at least one example embodiment of the inventive concepts effectively decreases and/or prevents an attack from triggering a security vulnerability in a manner of a random sequence of API abuses, and thus effectively protects a device driver and/or increases the security of the device driver, etc.

The API call method according to at least one example embodiment of the inventive concepts enables driver protection for an embedded device, effectively defends against attacks of interface abuses on the device driver, and/or avoids uncovering a security vulnerability through the API abuses.

The API abuse method according to at least one example embodiment of the inventive concepts is capable of generating a rapid response to, for example, a 0 day security vulnerability, and thus may be used as a system upgrade, etc. Limiting the triggering of the security vulnerability by updating the rules, e.g., by analyzing logic of API calls in the PoC to update the API call rules and produce an upgrade package, may enable the protection of the device driver from the attack before the security vulnerability is completely fixed by a device driver developer, operating system developer, etc.

The API call method according to at least one example embodiment of the inventive concepts uses and/or requires only a small portion of kernel file system codes to be modified to protect the product device, without modifying any source code of the product device driver, and may be easily and quickly applied to the product. Moreover, the protection is loaded only by implanting characters in an operating system without opening any interface to a user layer, and therefore no new driver-related attack surface is generated.

FIG. 6 is a block diagram illustrating an API call apparatus 600 according to at least one example embodiment of the inventive concepts.

Referring to FIG. 6, the API call apparatus 600 includes an API rule determination module 601, an API abuse determination module 602, and/or an API call execution module 603, etc. According to at least one example embodiment of the inventive concepts, an API includes an Input/Output control (ioctl) interface, but is not limited thereto. According to some example embodiments, one or more of the API rule determination module 601, the API abuse determination module 602, and/or the API call execution module 603, etc., may be implemented as processing circuitry. Processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

According to at least one example embodiment of the inventive concepts, the API rule determination module 601 may be configured to determine one or more rules corresponding to an API from a rule set in response to a call request for the API, etc.

According to at least one example embodiment of the inventive concepts, the API abuse determination module 602 may be configured to determine whether the API is abused based on the one or more rules as discussed above.

According to at least one example embodiment of the inventive concepts, the API call execution module 603 may be configured to execute a call of the API in response to determining that the API is not abused as discussed above.

According to at least one example embodiment of the inventive concepts, the API rule determination module 601 is configured to determine the one or more rules corresponding to the API from the rule set by: determining the one or more rules corresponding to the API from the rule set based on a command number of the API, etc.

According to at least one example embodiment of the inventive concepts, the rule set is represented by a hash table, wherein a key of the hash table represents a command number of an API and a value of the hash table represents a rule, but the example embodiments are not limited thereto. According to at least one example embodiment of the inventive concepts, the API rule determination module 601 may be configured to determine the one or more rules corresponding to the API from the rule set based on the command number of the API by: determining a node in the hash table corresponding to the command number as a head node of a linked list corresponding to the node, by indexing by the command number of the API; and traversing the linked list starting from the head node to determine the one or more rules corresponding to one or more nodes of the linked list, but the example embodiments are not limited thereto.

According to at least one example embodiment of the inventive concepts, the API abuse determination module 602 may be configured to determine whether the API is abused based on the one or more rules by: determining whether the API is abused based on a result of comparing an API status bitmap with the one or more rules, etc.

According to at least one example embodiment of the inventive concepts, the API abuse determination module 602 may be configured to determine whether the API is abused based on the result of comparing the API status bitmap with the one or more rules by: comparing values of the API status bitmap with configured and/or preconfigured call sequence values in each of the one or more rules; determining that the API is not abused, when there is a rule configured and/or preconfigured with a call sequence values which are the same as the values of the API status bitmap among the one or more rules; and determining that the API is abused, when there is no rule configured and/or preconfigured with a call sequence values which are the same as the values of the API status bitmap among the one or more rules, etc.

According to at least one example embodiment of the inventive concepts, the API call apparatus 600 may further include a rule set determination module, etc., (not shown in FIG. 6), and the rule set determination module may be implemented as and/or implemented in processing circuitry as well. The rule set determination module may be configured to determine the rule set corresponding to a target device from a plurality of set and/or pre-set rule sets when an open function is executed to turn on the target device to be driven by the API, etc.

According to at least one example embodiment of the inventive concepts, the API call apparatus 600 may further include an API status bitmap determination module (not shown in FIG. 6), but is not limited thereto. The API status bitmap determination module may be implemented as and/or implemented in processing circuitry as well. The API status bitmap determination module may be configured to: create an API status bitmap for recording an API call record and an API call result when an open function is executed to turn on the target device to be driven by the API; and updating the API status bitmap in response to executing the call of the API, etc.

According to at least one example embodiment of the inventive concepts, the API status bitmap determination module may be configured to update the API status bitmap by: performing the following update operations when a second position corresponding to the API in the API status bitmap is 0, the second position being used to record the API call result: updating a first position corresponding to the API in the API status bitmap to 1 in response to a successful calling of the API, the first position being used to record the API call record; and updating the second position to 1 and updating the first position to 0 in response to a failed calling of the API, etc.

With respect to the API call apparatus 600 in one or more example embodiments, wherein the specific manners in which each module performs operations, is described in detail in at least one example embodiments of the related methods described above, and will not be described in detail herein.

In addition, it should be understood that, the respective module in the API call apparatus 600 according to at least one example embodiment of the inventive concepts may be implemented with a hardware component and/or software component executed by hardware.

FIG. 7 is a block diagram illustrating an electronic device according to at least one example embodiment of the inventive concepts.

Referring to FIG. 7, the electronic device 700 may include at least one processor 701 and/or at least one memory 702 storing computer-executable instructions, etc., but is not limited thereto. The computer-executable instructions (e.g., computer readable instructions, etc.), when being executed by the at least one processor 701, cause the at least one processor 701 to perform the API call method. According to some example embodiments, one or more of the at least one processor 701 and/or the at least one memory 702, etc., may be implemented as processing circuitry. Processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

As an example, the electronic device 700 may be a PC computer, a laptop, a smartphone, a tablet, a personal digital assistant, and/or other apparatus capable of executing computer readable instructions. Herein, the electronic device 700 does not have to be a single electronic device, but may also be an assembly of any apparatus and/or circuit that are capable to execute the above computer readable instructions (and/or computer readable instruction sets) individually or jointly. The electronic device 700 may also be a part of an integrated control system and/or system manager, or may be configured as a portable electronic device that is interfaced with a local and/or remote device (e.g., via wired and/or wireless transmission).

In the electronic device 700, the processor 701 may include a central processing unit (CPU), a graphics processing unit (GPU), a programmable logic device, a specialized processor system, a microcontroller, and/or a microprocessor, etc. By way of example and not limitation, the processor 701 may also include an analog processor, a digital processor, a microprocessor, a multicore processor, a processor array, a network processor, and the like.

The processor 701 may execute the computer readable instructions or program codes stored in the memory 702, wherein the memory 702 may also store data, etc. The computer readable instructions and/or data may also be transmitted and/or received through a network via a network interface apparatus, wherein network interface apparatus may adopt any known transmission protocol.

The memory 702 may be integrated with the processor 701, for example, by placing a RAM and/or flash memory within an integrated circuit microprocessor, etc., but is not limited thereto. In addition, the memory 702 may include an independent device, such as, an external disk driver, a storage array, and/or other storage devices that may be used by any database system. The memory 702 and processor 701 may be coupled operationally, and/or they may communicate with each other, such as through an I/O port, a network connection, etc., so that the processor 701 is capable of reading a file stored in the memory 702.

According to at least one example embodiment of the inventive concepts, a non-transitory computer-readable storage medium storing computer readable instructions is also provided, wherein the computer readable instructions stored in the non-transitory computer-readable storage medium, when executed by at least one processor, cause the at least one processor to perform the above API call methods.

An example of non-transitory computer-readable storage medium herein includes: read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state hard disk (SSD), card memory (such as a multimedia card, secure digital (SD) card, or extreme digital (XD) card), magnetic tape, floppy disk, magneto-optical data storage device, optical data storage device, hard disk, solid state disk, and any other apparatus configured to store the computer applications and any associated data, data files and data structures in a non-transitory manner, and provide the computer applications and any associated data, data files and data structures to a processor and/or computer so that the processor and/or computer may execute the computer applications, but the example embodiments are not limited thereto. The computer applications in the above-mentioned non-transitory computer readable-storage medium may be executed in an environment deployed in an device such as a client, a host, a proxy apparatus, a server, etc., in addition, in at least one example, the computer applications and any associated data, data files and data structures are distributed over networked computer systems so that the computer applications and any associated data, data files and data structures are stored, accessed and executed in a distributed manner by one or more processors and/or computers.

According to one or more example embodiments of the inventive concepts, computer software may also be provided, computer readable instructions in the computer software may be executed by at least one processor to complete an API call method as described in the aforementioned example embodiments.

After considering the description and practicing the example embodiments of the inventive concepts disclosed herein, those skilled in the art are easily think of other example embodiments of the inventive concepts. The example embodiments cover any variation, use or adaptation of the inventive concepts, which follow general principles of the inventive concepts and include the common general knowledge or frequently used technical means in the technical field. The description of the example embodiments are only regarded as examples, and the true scope and spirit of the inventive concepts are indicated by the claims.

It should be understood that the example embodiments of the inventive concepts are not limited to the precise structure described above and shown in the drawings, and various modifications and changes may be made without departing from its scope. The scope of the inventive concepts is limited only by the claims.

1. An Application Programming Interface (API) call method, comprising:
determining, using processing circuitry of an electronic device, one or more rules corresponding to an API from a rule set in response to an API call request from an operating system (OS) of the electronic device associated with the API, the API including an Input/Output Control (ioctl) interface;
determining, using the processing circuitry, whether to allow the API call request based on the one or more rules; and
executing, using the processing circuitry, a call of the API corresponding to the API call request based on results of the determining.

2. The API call method according to claim 1, wherein the determining the one or more rules corresponding to the API from the rule set comprises:
determining the one or more rules corresponding to the API from the rule set based on a command number of the API.

3. The API call method according to claim 2, wherein
the rule set is included in a hash table;
the hash table includes a key corresponding to the command number of the API, and one or more values corresponding to the key represent the one or more rules corresponding to the API; and
the determining the one or more rules corresponding to the API from the rule set based on the command number of the API comprises,
traversing a linked list included in the hash table corresponding to the command number of the API based on the key to determine the one or more rules corresponding to the API, the one or more rules included in one or more nodes of the linked list.

4. The API call method according to claim 1, wherein the determining whether to allow the API call based on the one or more rules further comprises:
determining whether the API is being abused by comparing a status bitmap corresponding to the API with the one or more rules.

5. The API call method according to claim 4, wherein the determining whether to allow the API call further comprises:
comparing values included in the status bitmap corresponding to the API with call sequence values included in each of the one or more rules;
allowing the API call in response to the one or more rules including call sequence values which are same as the values of the status bitmap corresponding to the API; and
prohibiting the API call in response to none of the one or more rules including call sequence values which are the same as the values of the status bitmap corresponding to the API.

6. The API call method according to claim 1, further comprising:
determining, using the processing circuitry, the rule set corresponding to a target device from a plurality of preset rule sets in response to an open function of the API being executed to turn on the target device.

7. The API call method according to claim 1, further comprising:
creating, using the processing circuitry, a status bitmap corresponding to the API in response to an open function of the API being executed to turn on a target device, the status bitmap including API call records and API call results corresponding to the API; and
updating, using the processing circuitry, the status bitmap corresponding to the API in response to executing calls of the API.

8. The API call method according to claim 7, wherein the updating the status bitmap comprises, in response to a second position in the status bitmap corresponding to the API being 0, the second position being used to record the API call results corresponding to the API:
updating a first position in the status bitmap corresponding to the API to 1 in response to a successful calling of the API, the first position being used to record the API call record associated with the API; and
updating a second position to 1 in the status bitmap corresponding to the API and updating the first position to 0 in response to a failed calling of the API.

9. An Application Programming Interface (API) call apparatus, comprising:
processing circuitry configured to,
determine one or more rules corresponding to an API from a rule set in response to an API call request from an operation system of the apparatus for the API, the API comprises an Input/Output Control (ioctl) interface;
determine whether to allow the API call request based on the one or more rules; and
execute a call of the API corresponding to the API call request based on results of the determining.

10. The API call apparatus according to claim 9, wherein the processing circuitry is further configured to determine the one or more rules corresponding to the API by:
determining the one or more rules corresponding to the API from the rule set based on a command number of the API.

11. The API call apparatus according to claim 10, wherein
the rule set is included in a hash table;
the hash table includes a key corresponding to the command number of the API, and one or more values corresponding to the key represents the one or more rules corresponding to the API; and
the processing circuitry is further configured to determine the one or more rules corresponding to the API by,
traversing a linked list included in the hash table corresponding to the command number of the API based on the key to determine the one or more rules corresponding to the API, the one or more rules included in one or more nodes of the linked list.

12. The API call apparatus according to claim 9, wherein the processing circuitry is further configured to determine whether to allow the API call based on the one or more rules by:
determining whether the API is being abused by comparing a status bitmap corresponding to the API with the one or more rules.

13. The API call apparatus according to claim 12, wherein the processing circuitry is further configured to determine whether to allow the API call by:
comparing values included in the status bitmap corresponding to the API with call sequence values included in each of the one or more rules;
allowing the API call in response to the one or more rules including call sequence values which are same as the values of the status bitmap corresponding to the API; and
prohibiting the API call in response to none of the one or more rules including call sequence values which are the same as the values of the status bitmap corresponding to the API.

14. The API call apparatus according to claim 9, wherein the processing circuitry is further configured to:
determine the rule set corresponding to a target device from a plurality of preset rule sets in response to an open function of the API being executed to turn on the target device.

15. The API call apparatus according to claim 9, wherein the processing circuitry is further configured to:
create a status bitmap corresponding to the API in response to an open function of the API being executed to turn on a target device, the status bitmap including API call records and API call results corresponding to the API; and
update the status bitmap corresponding to the API in response to executing calls of the API.

16. The API call apparatus according to claim 15, wherein the processing circuitry is further configured to update the status bitmap corresponding to the API by:
updating a first position in the status bitmap corresponding to the API to 1 in response to a successful calling of the API, the first position being used to record the API call record associated with the API; and
updating a second position in the status bitmap corresponding to the API to 1 and updating the first position to 0 in response to a failed calling of the API.

17. (canceled)

18. A non-transitory computer-readable storage medium having computer readable instructions stored thereon, which when being executed by at least one processor, cause the at least one processor to:
determine one or more rules corresponding to an API from a rule set in response to an API call request from an operation system of an apparatus for the API, the API comprises an Input/Output Control (ioctl) interface;
determine whether to allow the API call request based on the one or more rules; and
execute a call of the API corresponding to the API call request based on results of the determining.
